(19) United States
(12) Patent Application Publication
(10) Pub. No.: US 2012/0066591 A1
(43) Pub. Date: Mar. 15, 2012

(54) Virtual Page Turn and Page Flip via a Touch Sensitive Curved, Stepped, or Angled Surface Side Edge(s) of an Electronic Reading Device

(75) Inventor: Samuel C. Hackwell, Lynden, WA (US)

(73) Assignee: Tina Hackwell, Lynden, WA (US)

(21) Appl. No.: 12/879,592

(22) Filed: Sep. 10, 2010

(51) Int. Cl. G06F 3/01

(52) U.S. Cl. 715/702

(57) ABSTRACT

An improved and more intuitive method of interacting and controlling the speed of a virtual page turn or virtual page flip, wherein a touch surface is a curved, stepped, or angled side edge surface of an electronic reading device. The rate or speed of virtual pages turned or flipped is determined by the physical location and gesture movement or direction of user's finger(s) on the curved, stepped, or angled touch surface. Typically, the common method of interacting and controlling the turning or flipping of virtual pages occurs on the flat front or top of the display touch screen surface, whereas this invention provides a more intuitive method of turning or flipping of virtual pages of electronic books which more naturally mimics that of turning or flipping through traditional paperback or hard-bound non-electronic book pages.

### FIELD OF INVENTION

The present invention relates to electronic reading devices and a method of interacting with virtual page turning and virtual page flipping.

### BACKGROUND OF THE INVENTION

Generally, electronic reading devices (including “electronic books” which are described in paragraph 13 under Claims) provides a means in which users can read electronic book files and other types of media and sheet-like or page-like files which are which are stored and displayed in a compact hand-held device. A user is thus allowed to transport, view, and interact with a large number of books, magazines, newspapers, journals, video, graphics, etc., in a single lightweight electronic reading device. Thus, text, image, video, audio, etc., can be viewed and listened to through electronic means of the electronic reading device.

A touch screen and touch surface incorporated into the referred electronic reading device, allows a user to interact intuitively with the electronic books in a user-friendly means. More specifically, relating to the invention, a touch surface area on an electronic reading device is capable of interacting with virtual pages within the electronic books.

Note: Hereafter, all forms of “electronic books”files will mean to include but not limited to, any and all types of electronic books of fiction and non-fiction, textbooks, magazines, newspapers, journals, maps, charts, brochures, pamphlets, booklets, documents, etc., as noted in paragraph 13 under “Claims”, and any and all text, graphics, images, video, or audio embedded therein.

### SUMMARY OF THE INVENTION

In this summary, a method of interacting with virtual page turning and virtual page flipping is disclosed. One or more virtual pages are displayed on a touch screen. A touch sensitive area allows a user to interact with the stored electronic media, in this case electronic books, and their respective virtual pages, by touching the surface or region located on the side edge of the electronic reading device via a user's finger. In general, the touch surface can recognize the touch and position of the touch on the touch sensitive surface and the computing system can interpret the touch and thereafter perform the desired action based on the touch gesture and position. In this case, virtual pages of electronic books are turned or flipped. Turning the touch sensitive area on or off is controlled by user input via soft buttons or other commands of the computing system.

When a user interacts by touch on the touch surface area of the electronic reading device, the direction of virtual “page turn” or virtual “page flip” is detected. Virtual page turning or page flipping occurs from either a right to left direction (meaning, the normal page turning direction a reader takes to progressively advance through a book as it is being read, also meaning, progressing from the beginning of the book to the end of the book), or, from left to right (the direction a reader takes as he/she flips back-through a book, or going in reverse order or direction as if the user is progressively going from the back of the book to the front of the book).

Also, this invention relates to a touch screen display panel that has or may have a transitional curved, stepped, or angled touch surface area on the side edge of the electronic device. The location of the curved or angled touch surface on the side edge (right or left side edges), lends itself to the traditional book-like method of turning through or flipping through paper pages, and is therefore intuitive in interacting with virtual pages within electronic books.

The virtual page turn and virtual page flip works in conjunction with the curved, stepped, or angled touch surface, in that the rate or speed of the virtual page turn or flip depends upon the location and direction of movement of user input. Virtual page turn or page flip rate increases as the finger is drawn over and downward along the curved, stepped, or angled surface side edge. The reverse is also true, in that the rate or speed of the virtual page turn or flip is slowed as the user's finger is drawn upward along the curved, stepped, or angled surface side edge. The virtual page turn or flip rate and speed stays constant when the user's finger hovers in one location on the touch surface side edge. The virtual page turn or flip is ceases when the finger of the user is removed from the touch surface and is no longer in contact. Refer to Detailed Description for a more thorough explanation of the method and means.

### BRIEF DESCRIPTION OF THE DRAWINGS

FIG. 1 is front view of a single electronic reading device display panel.

FIG. 2 is a front view of an electronic reading device with two display panels.

FIG. 3 is a perspective view of a single electronic reading device display panel showing curved, stepped, or angled touch surfaces on both side edges of display panel of FIG. 1.

FIG. 4 is a perspective view of an electronic reading device with two display panels showing curved, stepped or angled touch surfaces on side edges of display panels of FIG. 2.

FIGS. 5-6 are cross-sectional views of electronic reading device display panel showing curved, stepped, or angled touch surface on side edge of display panel of FIGS. 1 and 2, with FIG. 6 being an enlarged cross-section of FIG. 5; also showing continuous touch surface and their relative contact points along side edge.

FIGS. 7-10 are perspective views showing examples of various curved, stepped and angular touch surface side edges of FIGS. 1 and 2; also showing touch surface and their respective contact points along side edge.

FIG. 11 shows an example of a slow speed or single virtual page turn or virtual page flip in response to input gesture or touch on the touch screen or touch surface on right side edge of display panel of FIG. 2. Virtual pages composed of a front and back side (two-sided), similar to a traditional two-sided paper page of a conventional book.

FIG. 12 shows an example of a moderate speed virtual page turn or virtual page flip in response to input gesture or touch on the touch screen or touch surface on right side edge of display panel of FIG. 2. Virtual pages composed of a front and back side (two-sided).

FIG. 13 shows an example of an rapid speed virtual page turn or virtual page flip of multiple pages in response to input gesture or touch on the touch screen or touch surface on right side edge of display panel of FIG. 2. Virtual pages composed of a front and back side (two-sided).

FIG. 14 shows an example of a slow speed or single virtual page turn or virtual page flip in response to input gesture or touch on the touch screen or touch surface on left side edge of display panel of FIG. 2. Most virtual pages composed of a front and back side (two-sided), similar to a traditional two-sided paper page of a conventional book.

FIG. 15 shows an example of an moderate speed virtual page turn or virtual page flip of multiple pages in response to input gesture or touch on the touch screen or touch surface on left side edge of display panel of FIG. 2. Virtual pages composed of a front and back side (two-sided).

FIG. 16 shows an example of an rapid speed virtual page turn or virtual page flip of multiple pages in response to input gesture or touch on the touch screen or touch surface on right side edge of display panel of FIG. 2. Virtual pages composed of a front and back side (two-sided).

FIG. 17 illustrates a flow chart showing some of the logic of operation.

### DETAILED DESCRIPTION

In the following description of preferred method and functional design, reference is made to the accompanying drawings which form a part hereof, and in which it is shown by way of illustration of design and method thereof of the invention.

Touch sensor surface regions on the side edges 26 of the electronic reading device can be multi-touch and can identify and track the location and movement of user input.

The electronic reading device 10 with touch surface side edge(s) 26 is typically an electronic book but can be other types of electronic devices including, but not limited to; electronic books (ebooks), electronic tablets, all-in-one computers and their respective touch screens, laptop computers, personal data assistants, cellular or mobile communication devices, and other electronic devices capable of displaying electronic media material that can be viewed in a page-like or sheet-like format or fashion.

The material of the touch sensor surface regions 26, whether comprised of glass or plastic compounds or other suitable materials on the side edges of the electronic reading device 10 can be transparent or non-transparent.

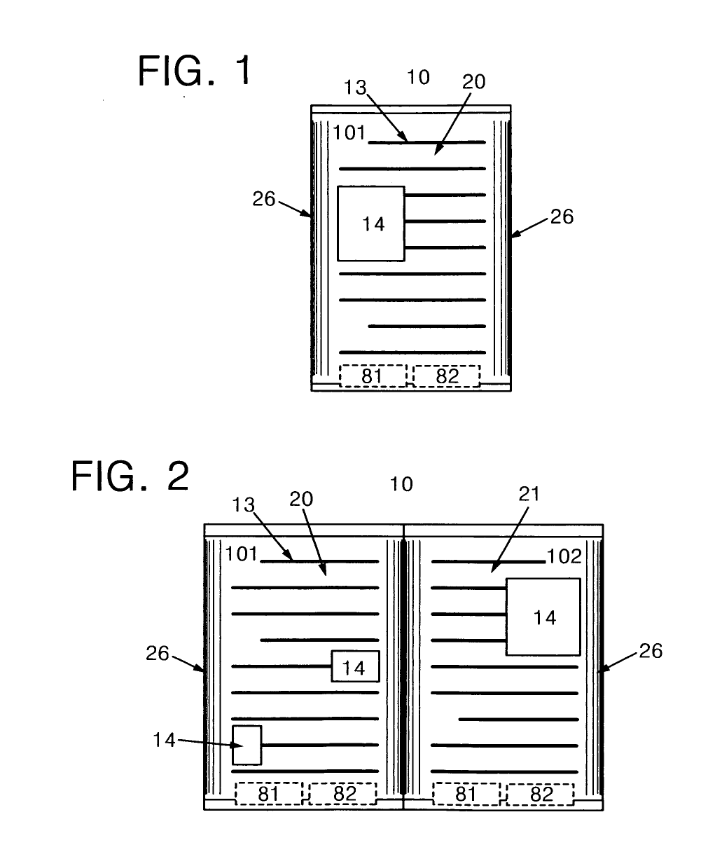

Referring to FIGS. 1 & 2, and example of electronic reading device 10 and composed of one or more touch screen display panels 20, 21. The herein disclosed methods, processes and design may be implemented on virtually any computing system having a touch display or touch surface area with a curved, stepped, or angled edge 26, including devices comprised of one touch screen display panel 20 or two or more touch screen display panels 21. Touch screen display panels 20 and 21 can be hinged together which facilitates various configurations for viewing and can be foldable for storage and transport.

Referring to FIG. 1, the electronic reading device 10 is shown visually presenting a virtual page 101 comprised of words 13 (depicted as black lines), and graphics 14; graphics 14 are to be understood to include graphics, video, images, photos, and other compositions.

Referring to FIG. 2, the electronic reading device 10 is comprised of two display panels 20,21, and is shown to visually present virtual pages 101 and 102 (i.e. right page 101 and left page 102) comprised of words 13 and graphics 14, wherein graphics 14 are to be understood to include graphics, video, images, and other compositions.

Electronic reading devices 10, comprising of two or more touch screen display panels 20,21, may utilize each such display for presenting a different virtual page(s) 101, 102+. The electronic reading device 10, comprised of one or more touch screen display panel(s) 20, 21, utilizes the side edge(s) 26 and the transitional area between the flat top area of the display touch screen 20, 21. The designated region of the touch surface side edge 26 can be a small specific region or area along the right or left side edge(s) 26 of the electronic reading device 10, or it can span the entire side edge(s) 26, or any portion or region thereof of the device's 10 side edge.

Referring to FIGS. 1 & 2, the electronic reading device 10, whether comprised of one or more touch screen display panels 20, 21+, includes a data holding subsystem(s) 81 and a logic subsystem(s) 82 and other necessary or optional components not shown in FIGS. 1 & 2 required for operation of said device 10 and for communicating between two or more devices 10+ (i.e., computing system, processor, wireless connection, etc.). The electronic reading device 10 with a touch surface edge 26 may be a surface computer, tablet computer, desktop computer, laptop computer, mobile communications device, personal data assistant, or virtually any other computer device that can incorporate a touch surface area or region on the side edge(s) near to or continual from its display capable of displaying virtual pages or other page-like or sheet-like virtuals.

The data subsystem 81 may include one or more physical devices configured to hold data and/or instructions executable by the logic subsystem 82 to implement the herein described methods and processes.

As described in more detail below, an electronic reading device 10 provides a user with a realistic virtual page turn and/or realistic virtual page flip interface which mimics the aspects of turning or flipping a physical page (or pages) of a conventional paperback or hardback book, or other virtual sheets, pages, papers, photos, charts, maps, documents, manuscripts, letters, etc., that are typically flat, thin, and flexible.

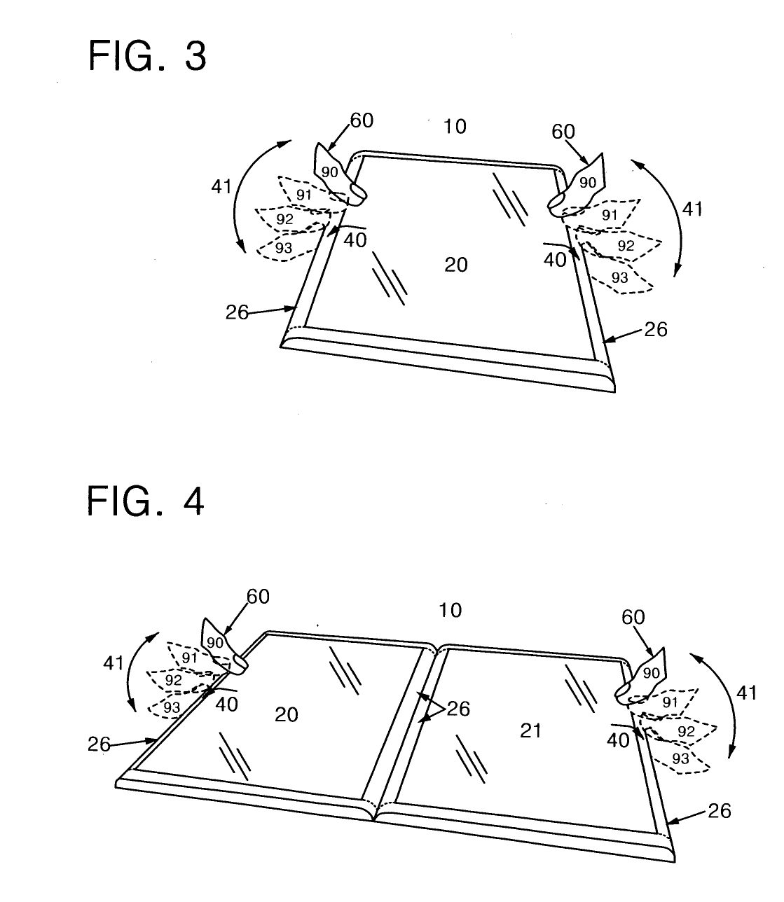

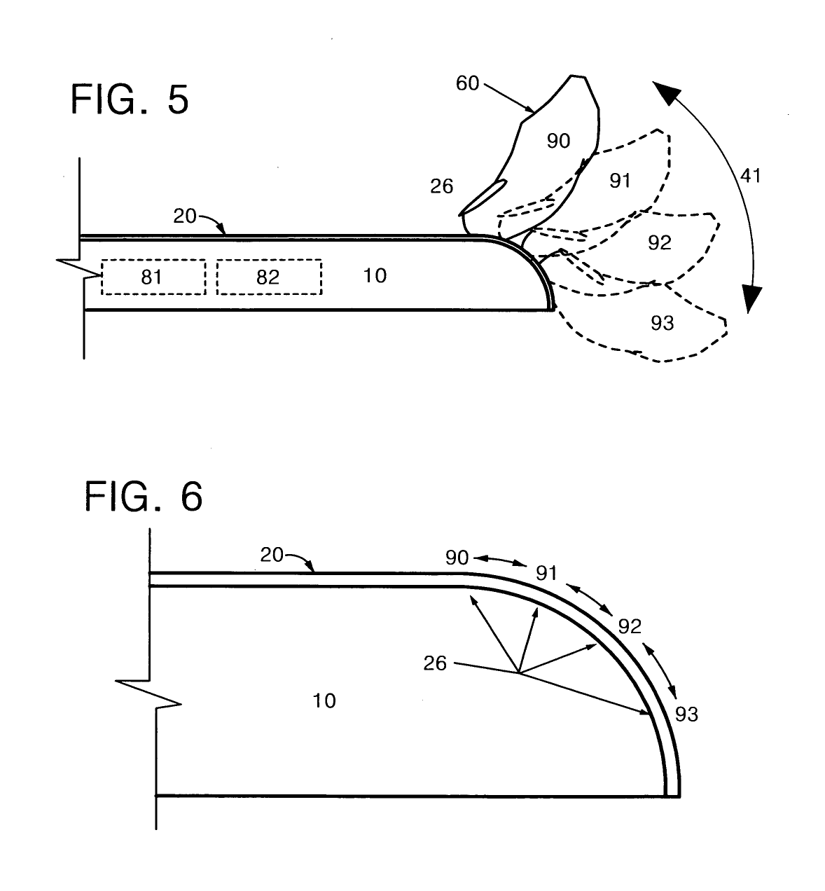

Referring to FIGS. 3,4,5,6, the electronic reading device 10, having touch surface side edges 26, receives user input (by user's finger/thumb) 60 sensitive to touch gesture(s) on surface and direction of movement being 40 or 41 on and along the touch screen 20 which transitions to the touch surface side edges 26. The position at which the user 60 touches the touch surface side edge 26 determines and directly relates to the rate or speed at which the virtual page turns flips 71. If, for instance, the user's finger/thumb 60 contacts the touch surface side edge 26 at position 91, the virtual page flip/turn occurs at a slow speed. If, the user's finger/thumb 60 contacts the touch surface side edge 26 at position 92 or moves in the direction from 91 to 92, the rate of virtual page flip/turn occurs at a moderate speed, meaning more than one virtual pages are being turned/flipped at the same time. If, the user's finger/thumb 60 contacts the touch surface side edge 26 at position 93, or moves in the direction from 91 to 92 to 93, or 92 to 93, the speed or rate of virtual page flip/turn occurs at rapid speed, meaning many virtual pages 71+ are being turned/flipped all at the same time. Virtual page flip/turn speed is variable and corresponds to the velocity and location of the gesture of the user's finger/thumb 60, and either accelerates or decelerates depending upon the direction of movement 40,41 of user's finger/thumb 60 along the curve, steps, or angle of the touch surface side edge 26 (either right or left side edge(s)).

When the user's finger/thumb 60 is removed from the touch surface 26, the action of the virtual page flip/turn is halted, and the virtual pages 71, 72, etc., advance to completion, whereupon the virtual page(s) are fully exposed to either the front or back of the respective virtual page(s).

A user's finger/thumb 60 can hover in contact with the touch surface side edge 26 of the electronic reading device 10, thus maintaining a steady virtual page flip/turn of the virtual pages 71+.

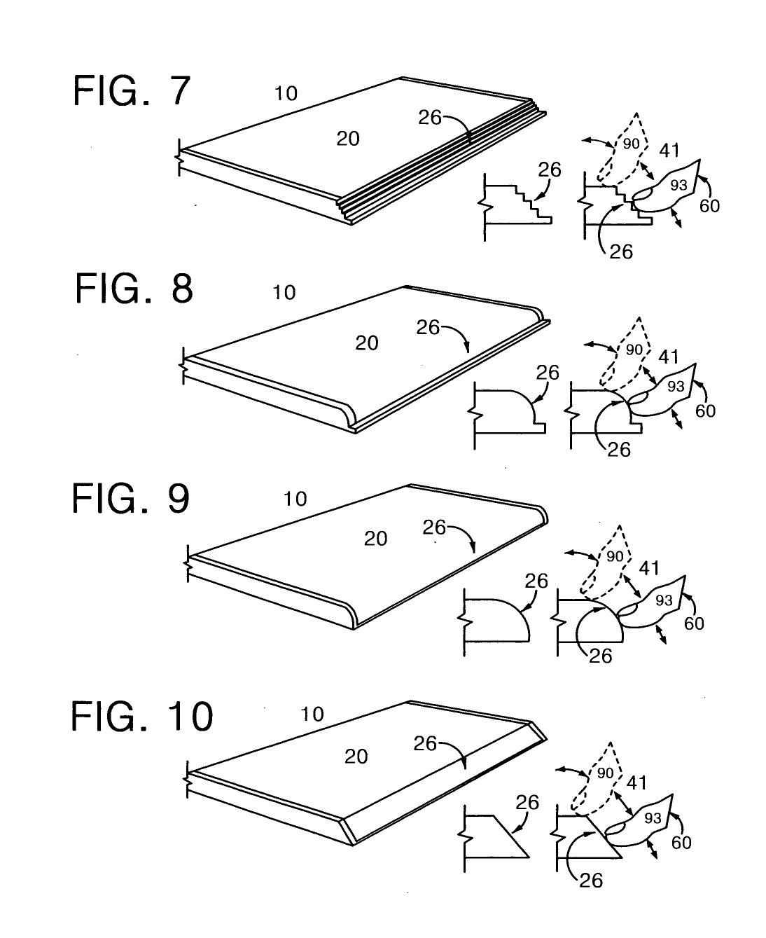

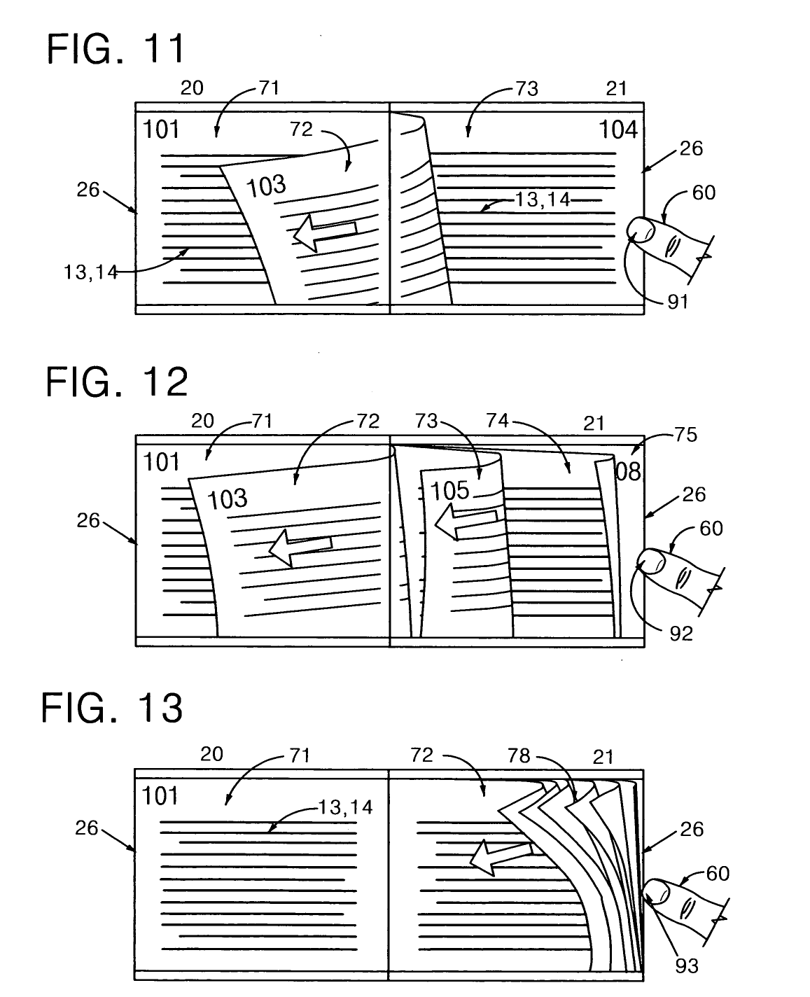

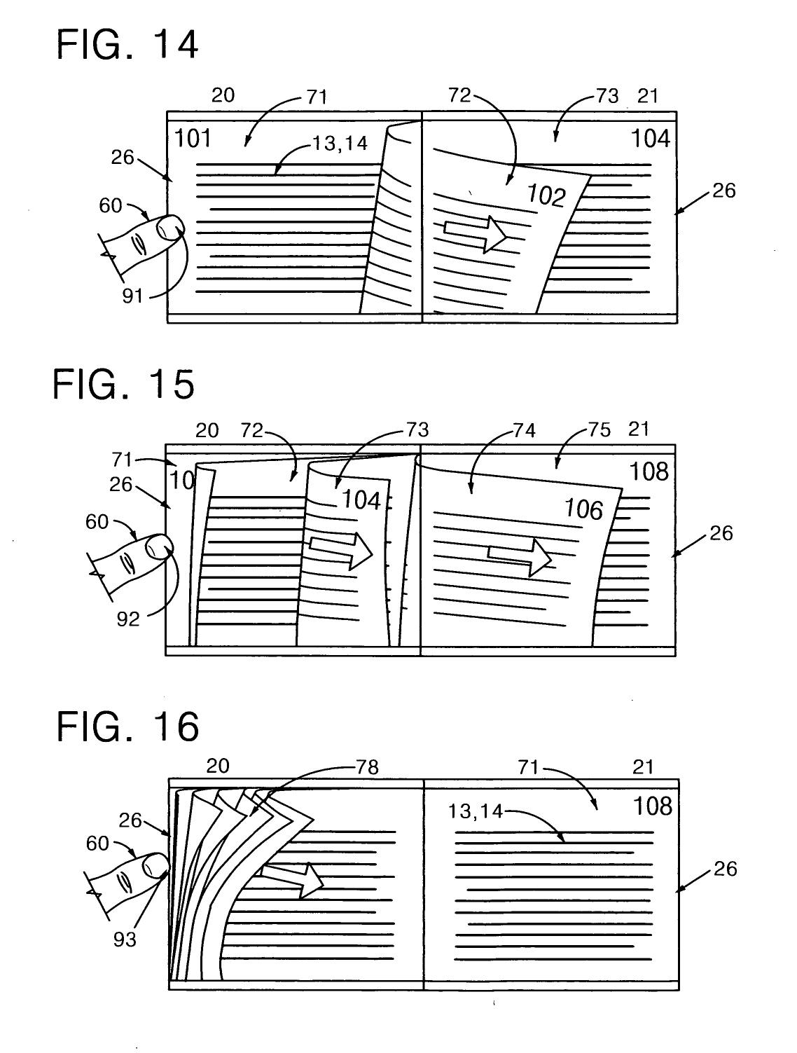

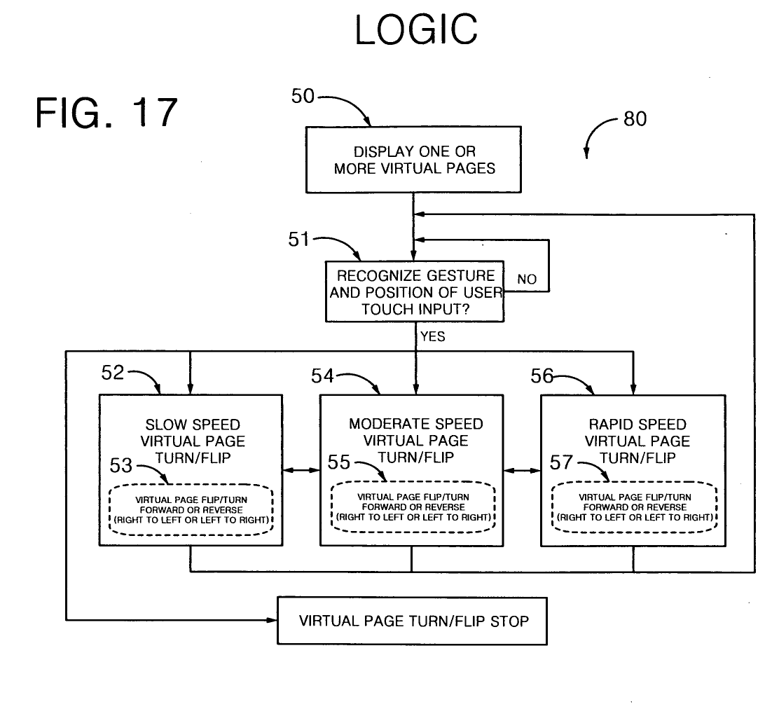

Referring to FIGS. 7-10, showing examples of various curved, stepped, and angular touch surface side edges 26. Touch surface side edge(s) 26 possibilities vary from an angled stepped edge in FIG. 7, which replicates the side edge of a traditional book when open for reading; FIGS. 8 and 9 show curved touch surface side edges 26; FIG. 10 shows an angled side edge; touch surface side edges are not limited to those shown.

1. An electronic reading device, comprising: a touch screen; a touch surface area or region adjacent or contiguous along the side of the touch screen; a logic system coupled operatively to the touch surface area(s) or region(s); a data holding subsystem with instructions executable by the logic system recognizing a virtual page turn or virtual page flip gesture command directed to the side of the virtual page corresponding to the side edge of the electronic reading device, whether the right side edge or the left side edge or both side edges of the device; a virtual page turn or virtual page flip program in which pages slowly or rapidly turn or flip is dependant upon the location of the user's finger contact location (or gesture motion) on the touch surface; whereupon removal of the user's finger contact from touch surface, virtual page turning or virtual page flipping discontinues.

2. A method of claim 1 for a virtual page turn and virtual page flip software program works in conjunction with either the curved, stepped, or angled touch sensitive side edge surface(s) of an electronic reading device which controls the rate at which the virtual page is turned or flipped relative to the position of the user's finger contact on the touch sensitive side edge(s).

3. The touch surface embodiment of claim 12 can either be transparent or non-transparent, and be composed of material(s) such as glass and or various compositions of plastics or other suitable materials.

4. Within the method of claim 1, the touch sensitive side edge(s) of the reading device is turned on or off (operable or non-operable) via a soft button or executable command.

5. The electronic reading device of claim 1, wherein the touch display screen can extend over and down the curved or angled side edge of the electronic reading device, thus displaying virtual pages and their respective page edges; or, the touch screen display screen transitions into a touch surface area which continues and extends over and down the curved, stepped, or angled side edge of the electronic reading device.

6. The method of claim 1, wherein the data holding subsystem holds instructions executable by the logic subsystem and is responsive to the user's finger contact and gesture along the side edge(s) of the touch surface, whereupon the virtual page turn or virtual page flip rate of speed, whether accelerating, decelerating, or maintaining a constant speed of the virtual page turning or flipping, occurs.

7. The method of claim 1, wherein the rate of virtual page turn or virtual page flip, and the number of virtual pages being turned or flipped corresponds to the location of the physical contact or gesture of the user's fingers on the touch surface side edge(s).

8. The method of claim 1, wherein it is understood that the curved, stepped, or angled touch surface(s) can be located on the right or left or both side edges of the electronic reading device.

9. The method of claim 1, wherein the actual touch surface edge(s) can be curved, stepped, angled, or any combination thereof, and the touch surface material can be composed of, but not limited to, glass or various plastic(s), transparent or non-transparent, and or other suitable materials.

10. The method of claim 1, whereupon a user's finger input can hover and stay in constant contact on the touch surface which signals the computer subsystem to maintain a continual and steady rate of virtual page turning or virtual page flipping; and any movement of the user's finger on the touch surface, whether moving it in a downward or upward movement on the side edge either slows or accelerates the virtual page flipping or turning; therefore the virtual page turn or virtual page flip accelerates or progressively accelerates as the thumb or finger is moved from the top of the touch surface edge downward along the side edge, and the virtual page turn or virtual page flip decelerates or progressively decelerates as the thumb or finger is moved from the bottom of the touch surface side edge upward; and at any time the finger is stopped and hovers at a certain contact point along the curved, stepped, or angled touch surface side edge, the rate of virtual page turning or virtual page flipping stays constant; and, if the user's finger is removed from the touch surface, the virtual page turning or virtual page flipping ceases.

11. The method of claim 1, wherein it is understood that the virtual page turn and virtual page flip occurs from a left to right direction over a single display screen or two or more display screens comprising an electronic reading device; and, that the virtual page turn and virtual page flip can occur from a right to left direction over a single display screen or two or more display screens comprising an electronic reading device; also, whereupon the data holding subsystem holds instructions executable by the logic subsystem which recognizes a reversal in the virtual page turning or virtual page flipping and is responsive to a reversal in the virtual page turning or virtual page flipping gesture from left to right or right to left direction over one or more display screens.

12. The types of electronic reading devices wherein the curved, stepped, or angled touch surface side edge(s) can be incorporated include, but are not limited to; electronic books (ebooks), electronic tablets, all-in-one computers and their respective touch screens, laptop computers, personal data assistants, cellular or mobile communication devices, and other electronic devices capable of displaying electronic books or similar type files.

13. Electronic book files are defined as, but not limited to the following files; electronic books—fiction and non-fiction, textbooks, magazines, journals, brochures, booklets, sheets, charts, maps, monthly planners, pamphlets, documents (paginated or otherwise), photos, images, letters, manuscripts, and which contain their respective text, graphics, images, videos, and audio embedded within any of the sheet-like or page-like documents.
